(19) United States
(12) Patent Application Publication
(10) Pub. No.: US 2013/0179306 A1
(43) Pub. Date: Jul. 11, 2013

(54) MOBILE COMPUTING DEVICE CONFIGURED TO EXECUTE A MULTI-DIMENSIONAL FUNCTION PRESENTED ON A VISUAL MEDIA

(71) Applicants: Roy Want, Los Altos, CA (US); William Noah Schilit, Mountain View, CA (US)

(72) Inventors: Roy Want, Los Altos, CA (US); William Noah Schilit, Mountain View, CA (US)

(73) Assignee: Google Inc., Mountain View, CA (US)

(21) Appl. No.: 13/612,386

(22) Filed: Sep. 12, 2012

Related U.S. Application Data
(60) Provisional application No. 61/594,148, filed on Feb. 2, 2012.
(60) Provisional application No. 61/583,975, filed on Jan. 6, 2012.

(51) Int. Cl. G06F 17/00; H04B 5/00; G06Q 20/32

(52) U.S. Cl. 705/26.81; 235/375

(57) ABSTRACT

A multi-dimensional function presented on a visual media including a plurality of tags associated with a plurality of parameters of the function is electronically executed using a mobile computing device. Each of the tags is interpretable by the mobile computing device. The mobile computing device interacts with two or more of the tags of the visual media to select values for two or more of the parameters of the function. The function is executed according to the selected values for the two or more parameters.

This application claims the benefit of U.S. Provisional Application No. 61/583,975, filed Jan. 6, 2012, and U.S. Provisional Application No. 61/594,148, filed Feb. 2, 2012, the entire contents of which are incorporated herein by reference.

### TECHNICAL FIELD

This disclosure relates to mobile computing devices.

### BACKGROUND

Mobile computing devices provide the benefit of being portable while allowing a user to perform a variety of functions including various forms of communication and computing. For example, some mobile devices are capable of accessing the Internet, executing gaming applications, playing videos and music, as well as a number of other useful functions. One type of mobile device is a portable computer, such as a laptop, netbook, or tablet computer. Another type of mobile device is a mobile phone, such as a smart phone with a touch screen interface. Mobile devices are employed for a number of functions. Recently, visual media has been combined with mobile device technology to improve and enhance the presentation of information to consumers, among other reasons. The types of visual media varies, but may include physical placards or posters that present information but also include tags that are interpretable by mobile devices to, e.g., access additional information related to information presented on the poster.

### SUMMARY

One example according to this disclosure includes a method of electronically executing a multi-dimensional function presented on a visual media comprising a plurality of tags associated with a plurality of parameters of the multi-dimensional function, in which each of the tags is interpretable by a mobile computing device. The method includes interacting, by the mobile computing device, with two or more of the tags of the visual media to select values for two or more of the parameters of the function, and executing the function according to the selected values for the two or more parameters.

In another example, a mobile computing device includes means for interacting with a plurality of tags associated with a plurality of parameters of a multi-dimensional function presented on a visual media, and a processor. The processor is configured to receive data from the means for interacting indicating interactions with two or more of the tags of the visual media to select values for two or more of the parameters of the function and execute the function according to the selected values for the two or more parameters.

In another example, a computer readable storage medium comprising instructions for causing at least one programmable processor to perform operations including receiving data indicating interactions with two or more tags of a visual media comprising a plurality of tags to select values for two or more parameters of a multi-dimensional function presented on the visual media, and executing the function according to the selected values for the two or more parameters.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that may be used to electronically execute a multi-dimensional function presented on a visual media using a mobile computing device.

FIG. 2 is a block diagram illustrating an example mobile computing device of the system of FIG. 1.

FIG. 3 is a block diagram illustrating an example visual media including near-field communication tags interpretable by a mobile computing device.

FIG. 4 is a flowchart illustrating an example of using a mobile computing device to electronically execute a multi-dimensional function presented on a visual media.

FIGS. 5A and 5B are block diagrams illustrating two additional examples of visual media presenting multi-dimensional functions for electronic execution by a mobile computing device.

### DETAILED DESCRIPTION

Examples according to this disclosure are directed to electronically executing a function presented on a placard using a mobile computing device, which requires multiple parameter inputs from a user for execution of the function, e.g. buying a product or service or completing a survey. The placard may be, for example, a physical poster and includes a number of tags interpretable by a mobile computing device to select a number of values of parameters of the function and to initiate execution of the function. The tags may include electronic or optical tags. For example, electonic tags may include near field communication (NFC) tags. Optical tags may be employed as well, including barcodes with parallel spaced lines of varying width, as well as matrix barcodes, such as Quick Response (QR) codes.

A placard including visual media, e.g. a poster may be employed to allow a mobile computing device, e.g. a smartphone to scan QR codes or NFC tags which augment printed media on the poster to perform some function. Such posters including visual media and various tags, e.g. NFC tags, associated therewith are sometimes referred to as “smart posters.” The term “smart poster” as used in this disclosure may refer to, e.g., a poster including visual media some or all of which is associated with a number of tags interpretable by a mobile computing device to select parameters according to which a multi-dimensional function presented on the poster may thereby be executed.

In one example, a smartphone is capable of interpreting the tags on the poster and thereby capable of executing the function presented on the poster. For example, a smartphone may be tapped against or in close proximity to NFC tags embedded in the poster to initiate execution of the function associated with the tag. In an example employing optical tags, like QR codes, a camera on the phone could be used to take a picture of and then read a QR code on the poster to initiate execution of the function associated with the interpreted code. Such phone-to-smart poster interactions may allow, for example, access to additional information associated with links on the poster and viewable on the phone. These links may include access to web services, a “buy product” or “buy service” option, maps, expanded background information etc., and may be in the form of webpages that a user could interact with. However, there are many situations in which a user would like to use this tangible interaction approach (e.g. tapping the poster with the phone) for more complex functions than simply linking to additional information or functions viewed/executed on the user's phone, e.g. functions including a number of different parameters or options that define execution of the function. For example, the user may wish to use the smart poster and phone to select a number of product options before and only then commit to a purchase of the product according to the selected options. An alternative is to continue the interaction on a small phone screen which may be slow, error prone, and may not be easily seen by other members of a group.

In one example, a user may employ a mobile computing device and a smart poster to order a pizza including different kinds of crusts, like thick or thin, the type of pizza, like Margareta or Hawaiian, or different individual toppings, like pepperoni, sausage, and onions, as well as the size, like 10 inch, 12 inch, and 16 inch. Such a transaction could be achieved simply by touching the phone to graphical images of the various options on the poster, where the selected options are each associated with a tag on or behind the poster. The final selection may be a “buy pizza” link which is aware of the previous chain of options selected by the user.

Another example is an interactive shopping poster at a store, e.g. a big box electronics store. In such an example, a user may select “start” on the poster and see a list of a 100 televisions on their phone or tablet. They scan, e.g., NFC tags on the poster for 3D (or 2D), 36-inch (or another size), and each time the list of televisions choices is filtered on their phone, presenting the user with an increasingly smaller list of televisions to look at, investigate specifications and other information before purchasing or just viewing in the store.

However, there is currently no mechanism that allows a user to simply move a phone over a smart poster to construct and execute a multi-command, or multi-option, function, or, in other words, a multi-dimensional function executable according to a plurality of parameters. Thus, one example according to this disclosure includes a method of electronically executing a multi-dimensional function presented on a placard including a plurality of tags associated with a plurality of parameters of the multi-dimensional function. Each of the tags is interpretable by a mobile computing device. The method includes interacting, by the mobile computing device, with two or more of the tags of the placard to select values for two or more of the parameters of the function and executing, by the mobile computing device, the function according to the selected values for the two or more parameters.

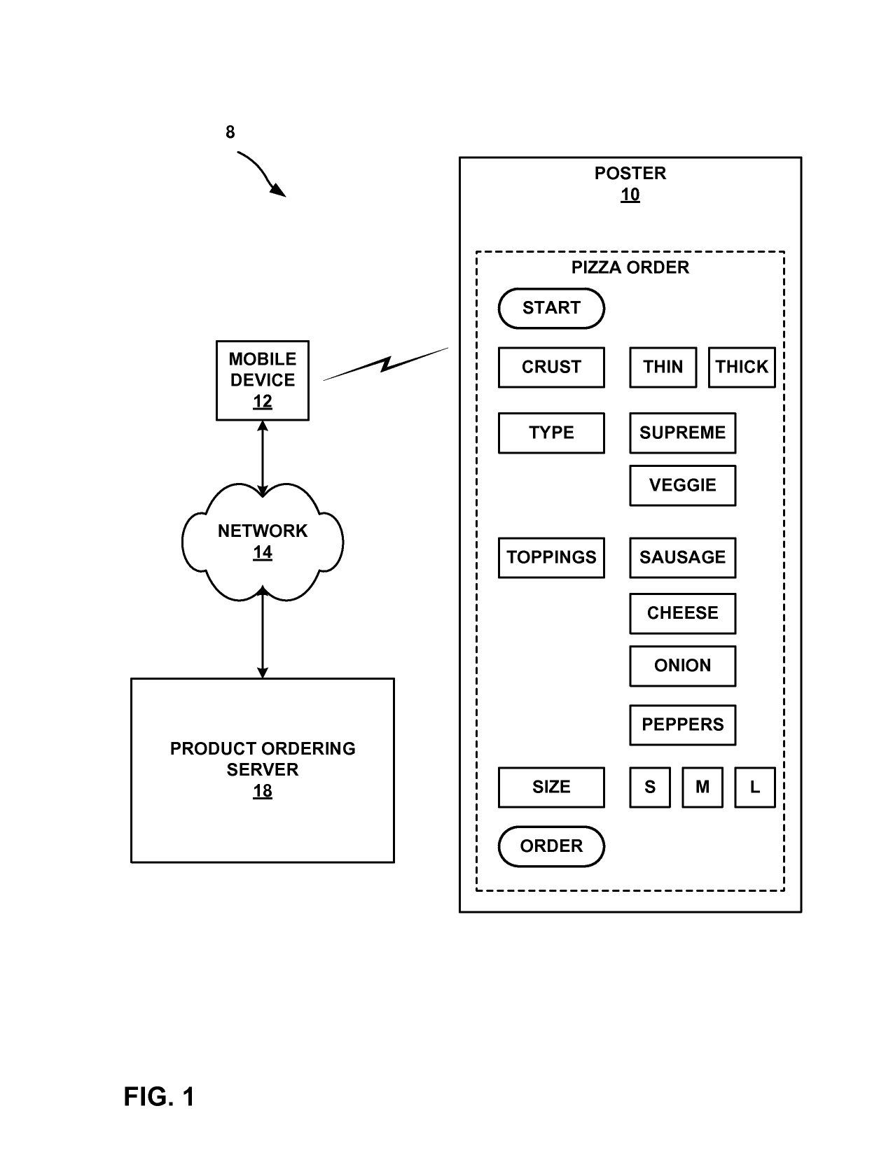

FIG. 1 is a block diagram illustrating example system 8 including smart poster 10, mobile computing device 12 (hereinafter “mobile device 12”), network 14, and product ordering server 18. In one example, smart poster 10 includes visual media related to a product offering by a company some or all of which is associated with a number of tags interpretable by mobile device 12 to select parameters according to which a multi-dimensional function presented on the poster may thereby be executed. In the example of FIG. 1, smart poster 10 may include visual media related to different options for ordering a pizza electronically, including the crust type and specialty pizza type, as well as additional individual toppings, and size. Portions of the visual media on poster 10 may be associated with tags, e.g. NFC tags interpretable by mobile device 12 to select different values for parameters of the pizza order that ultimately may define the order. For example, the values presented on smart poster 10 for crust type, thin or thick, specialty pizza type, supreme or veggie, toppings, sausage, cheese, onion, or peppers, and size, small, medium, or large, may each be associated with an NFC or other type of tag that may be interacted with by mobile device 12 to configure the pizza order according to a number of the different possible values.

As described herein, tags associated with smart poster 10 may be capable of short-range communication. One example of short-range communication is near-field communication (NFC). NFC communication can occur between two devices in different modes. For example, mobile device 12 may operate in at least two different modes to communicate with tags of smart poster 10 using NFC. For example, mobile device 12 and NFC tags on or embedded in poster 10 may be configured to operate in a passive mode and an active mode of operation. In an active mode of operation, mobile device 12 may generate a first alternating magnetic field that is received by one of the NFC tags of smart poster 10 in relatively close proximity to mobile device 12 (e.g. less than approximately 2.5 centimeters). In response, the NFC tag may generate a second alternating magnetic field that is received by mobile device 12. In this way, data may be communicated between mobile device 12 and the NFC tag of smart poster 10 such as using peer-to-peer communication. In the active mode, mobile device 12 may also power or activate a passive device to retrieve data from the passive device, as further described below. In this manner, NFC tags of smart poster 10 may include passive near-field communication hardware.

In a passive mode of operation, load modulation techniques may be employed to facilitate data communication between mobile device 12 and NFC tags of smart poster 10. In a passive mode, an NFC tag does not actively generate an alternating magnetic field in response to the alternating magnetic field of mobile device 12, but only as a result of the induced voltage and applied load by mobile device 12 at the NFC tag's receiver. Instead, the NFC tag of smart poster 10 may include electrical hardware (e.g., an NFC module) that generates a change in impedance in response to the alternating magnetic field generated by mobile device 12. For example, mobile device 12 may generate an alternating magnetic field that is received by the NFC tag when mobile device 12 is brought into proximity with the NFC tag on or embedded in smart poster 10. Electrical hardware in the NFC tag may generate a change in impedance in response to the alternating magnetic field. The change in impedance may be detected by the NFC module of mobile device 12. In this way, load modulation techniques may be used by mobile device 12 to obtain information from the NFC tag of poster 10. In other words, mobile device 12 may obtain information from the NFC tag, but the tag would not receive any data from mobile device 12 in the passive mode. Other well-known modulation techniques including phase modulation may also be employed to facilitate data communication between mobile device 12 and tags associated with smart poster 10 in other examples.

In some examples, each of the NFC tags of smart poster 10 may operate in passive mode. In passive mode, such NFC communication devices may be referred to as tags or targets. In such examples, mobile device 12 may include active NFC hardware, while the NFC tags of smart poster 10 may include passive NFC hardware. Since a passive NFC tag does not need a dedicated power supply, the tags associated with smart poster 10 may be placed in a variety of locations, on any surface, or even as part of smaller items. For example, the NFC tags may be embodied as a sticker or adhesive that is placed on smart poster 10, or, other examples, on the wall of a building or on a mounting surface to which different visual media is attached. With reference to the example of FIG. 1, passive NFC tags may be placed on smart poster 10 such that they are respectively associated with different steps/parameters in the pizza ordering function presented by the poster. For example, an NFC tag may be positioned to be associated with each of the values for the crust and pizza type, toppings, and size presented on smart poster 10. Passive NFC tags may also be less expensive and more difficult to corrupt with mobile device 12. In this manner, position devices 24 may include electrical hardware that generates a change in impedance in response to an alternating magnetic field. However, each of position devices 24 may be another computing device in other examples. For example, smart poster 10 may include tags, one or more of which may be a computing device that operates in a passive NFC mode and/or an active NFC mode.

Although the example of FIG. 1 and other examples are described below with reference to interaction between a mobile device and a poster, other visual media may be employed in examples according to this disclosure. Examples according to this disclosure may be carried out with visual media including any structure that provides visual information to a user. For example, examples according to this disclosure may include interactions with visual media including a printed flyer, coated surface, electronic media (e.g., a liquid crystal display), or any other surface that includes visual information such as text, numbers, images, and the like. Regardless of the form, the visual media may be directed to a single subject (e.g., a movie advertisement or a restaurant menu), or may include multiple subjects (e.g., different store advertisements or coupons). In one example, the visual media interacted with by a mobile device to electronically execute a multi-dimensional function may take the form of a weekly sales poster, an interactive item list for adding items to a shopping list, a building directory, or even photos of different people.

Mobile device 12 is communicatively connected to product ordering server 18 via network 14 and is in proximity with smart poster 10 such that the device may interact with the poster, e.g. by interpreting one or more of the tags on or embedded in the poster. Mobile device 12 is capable of interpreting the tags on smart poster 10 and thereby capable of electronically executing the multi-dimensional function presented on the poster, in this case electronically ordering a pizza. In one example, mobile device 12 may be tapped against or placed in close proximity to NFC tags on or embedded in smart poster 10 to exchange data with the tag or to execute some function. In an example employing optical tags like QR codes, a camera on mobile device 12 could be used to take a picture of and then read a QR code on smart poster 10 to gather data from the tag or to execute some function associated with the interpreted code.

Mobile device 12 may include a short-range communication module (not shown) capable of initiating wireless communication with, e.g. NFC tags on or in smart poster 10, over a relatively short distance. NFC tags may communicate over distances ranging from, e.g., 100 meters to less than 10 centimeters. In some examples according to this disclosure, mobile device 12 may initiate communication with tags of smart poster 10 when mobile device 12 is within, e.g., approximately 1 meter to approximately 5 centimeters of the poster. In another example, mobile device 12 may initiate communication with tags of smart poster 10 when mobile device 12 is less than 2.5 centimeters from the poster. In one example, a user may place mobile device 12 directly over or even touching smart poster 10 such that mobile device 12 may communicate with the tag at that particular location on the poster. If the user moves mobile device 12 across smart poster 10, mobile device 12 may communicate with different tags as mobile device 12 is moved.

In accordance with the examples described above with reference to near-field communications between mobile device 12 and smart poster 10, in one example, an NFC tag of smart poster 10 may deliver information related to the pizza order to mobile device 12 in response to receiving an alternating magnetic field generated by the NFC module of mobile device 12. In other words, information related to the pizza order, e.g. values of parameters like crust or pizza type, toppings, and size may be stored on the NFC tags of smart poster 10. Upon receiving the alternating magnetic field (e.g., receiving power sufficient to transmit data) mobile device 12 may receive the information related to the pizza order from one of the NFC tags of smart poster 10. In this manner, NFC tags may only be capable of delivering or sending information when mobile device 12 is within close physical proximity to each respective tag of smart poster 10. Although the user may physically touch, bump, or tap mobile device 12 to NFC tags of smart poster 10, mobile device 12 may be capable of receiving information from the tags without physically touching poster 10 and/or the tags of poster 10.

Mobile device 12 and product ordering server 18 are configured to periodically communicate with one another over network 14 to exchange data related to the multi-dimensional function electronically executed by mobile device 12 via interaction with smart poster 10. In the example of FIG. 1, the multi-dimensional function so executed by mobile device 12 includes electronically ordering a pizza. Product ordering server 18 may include a remote computing device, or “cloud” device of a provider of the pizza presented on smart poster 10 that is configured to receive the order from mobile device 12 and communicate the order to the pizza provider for fulfillment.

Mobile device 12 may include any number of different portable electronic mobile devices, including, e.g., cellular phones, personal digital assistants (PDA's), laptop computers, portable gaming devices, portable media players, e-book readers, watches, as well as non-portable devices such as desktop computers. Additionally, mobile device 12 may be employed in the disclosed examples by different types of users, including, e.g., test users and consumers. Test users may include employees of the mobile device and/or software manufacturer data associated with whom is tracked or exchanged via mobile device and remote devices over a network, while consumers may be the purchasers of the devices. In some examples, the type and amount of data collected from or exchanged with mobile device 12 by and between product ordering server 18 may depend on the type of user associated with a particular device or a number of devices. In any case, regardless of the type, system 8 may be configured such that users may opt-in or opt-out of data collection from or data transmission to mobile device 12.

Network 14 may include one or more terrestrial and/or satellite networks interconnected to provide a means of communicatively connecting mobile device 12 to product ordering server 18. For example, network 14 may be a private or public local area network (LAN) or Wide Area Network (WANs). Network 14 may include both wired and wireless communications according to one or more standards and/or via one or more transport mediums. For example, network 14 may include wireless communications according to one of the 802.11 or Bluetooth specification sets, or another standard or proprietary wireless communication protocol. Network 14 may also include communications over a terrestrial cellular network, including, e.g. a GSM (Global System for Mobile Communications), CDMA (Code Division Multiple Access), EDGE (Enhanced Data for Global Evolution) network. Data transmitted over network 14, e.g., from mobile device 12 to product ordering server 18 may be formatted in accordance with a variety of different communications protocols. For example, all or a portion of network 14 may be a packet-based, Internet Protocol (IP) network that communicates data from mobile device 12 to server 18 in Transmission Control Protocol/Internet Protocol (TCP/IP) packets, over, e.g., Category 5, Ethernet cables.

Product ordering server 18 may be any of several different types of network devices. For example, server 18 may include a data processing appliance, web server, specialized media server, personal computer operating in a peer-to-peer fashion, or another type of network device. Additionally, although example system 8 of FIG. 1 includes one server 18, other examples may include a number of collocated or distributed servers configured to process pizza orders from a large number of mobile device users individually or in cooperation with one another.

Product ordering server 18 may include one or more data storage and retrieval mechanisms for storing and retrieving data related to electronic pizza orders. Such data repositories included in server 18 may include, e.g., a standard or proprietary electronic database or other data storage and retrieval mechanism. Data repositories of server 18 may be implemented in software, hardware, and combinations of both. For example, a data repository on server 18 may include proprietary database software stored on one of a variety of storage mediums on a data storage server connected to network 14 and configured to store information associated with electronic pizza orders executed by mobile device users, e.g. a user of mobile device 12. Storage medium included in or employed in cooperation with a data repository on server 18 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media. Although such data repositories are described as integrated with product ordering server 18, in other examples, server 18 could be separate from an independent component that functions as a data repository. For example, a separate data repository may include device connected to network 14 that includes an array of storage devices configured to store, categorize, and associate large amounts of data. In another example, a separate data repository may be distributed among a number of separate devices, e.g. a number of database servers, and server 18 may include a number of co-located or distributed servers configured to operate individually and/or in cooperation with one another and with the various devices comprising the data repository.

Regardless of the particular configuration of system 8, or other example systems according to this disclosure, the system may be employed to solve the challenges of executing a multi-dimensional function according to a plurality of parameters with the concept of interactive sessions between mobile device 12 and smart poster 10 containing command-chains. In one example, this is achieved by utilizing information embedded in each tag on smart poster 10 describing its function/option, and providing a “continuation marker” that indicates more information is needed to complete the function. There may also be special markers in some tags, e.g. a marker that starts a chain “begin marker,” and another one that ends the chain “end marker.” The final tag may signal that a completed action command needs to be executed, such as “purchase item,” or, in the example of FIG. 1, “order pizza.” However, it may be possible to utilize the command chain to electronically execute a function at any intermediate point in the process.

Consider the example of electronically ordering a pizza with a mobile device and a smart poster described above and illustrated in FIG. 1. An “Order Pizza” poster 10 may include a graphic labeled “Start” for starting the order process. The tag associated with the start label may be an NFC tag that stores a begin marker to indicate that the start label initiates the process of electronically ordering the pizza. In one example, touching mobile device 12 at the location of the start label of smart poster 10 and the associated tag, e.g. NFC tag may function to clear any previous items that had been selected and begin a new session with an initially empty command-chain. Then, for example, a user employing mobile device 12 may tap their device near or against the various pizza order parameters of poster 10. For example, mobile device 12 may be tapped against labels for selecting crust, pizza type additional toppings, and size. Each such parameter may include multiple parameters. As illustrated in the example of FIG. 1, crust may include thin or thick, type may include supreme or veggie, toppings may include sausage, cheese, onion, and peppers, and size may include small (S), medium (M), and large (L). These are merely examples and in other examples according to this disclosure a function executed using a mobile device and a poster may include more or fewer parameters, each of which may include at least one value.

With reference to the example of FIG. 1, each NFC tag associated with the different labels presented on poster 10 for different options associated with the pizza, or, in other words, different parameters of the pizza ordering function may convey its attribute to mobile device 12, but may also contain a continuation marker (a “+” could be used) letting mobile device 12 know there are more attributes to come. This information can also be displayed on a display of mobile device 12 with text, or graphics, so that the user will know what has already been selected. In one example, if a user error occurs, they may be able to scan a “delete last item” tag with mobile device 12 to remove it. In one example, an application executed on mobile device 12 in connection with interactions with smart poster 10 or other similarly functioning visual media may present a user with an option, at any time while electronically executing a function, to delete the last selected parameter or value. Additionally, the command chain generated as mobile device 12 interacts with smart poster 10 could be visually represented to the user, e.g. as a series of objects, each of which indicates the various selections, e.g. a graphic or text including representations of thin crust, veggie pizza, and extra cheese topping. In such a case, mobile device 12 could provide the user with one or more user interface controls for deleting any one or more of the parameters previously selected for the pizza order.

In any event, when the order contains the correct information, the user may scan the NFC tag associated with the “order” label on smart poster 10 with mobile device 12 which may function to indicate completion of the command chain, e.g. with an end marker, and then the full command may be sent to a remote computing device, e.g. product ordering server 18 via network 14 to order the pizza. For example, mobile device may concatenate all of the parameter value selections and markers to generate a complete command chain, which is sent to product ordering server 18 to process and procure the pizza order. A command chain in the example of ordering pizza using mobile device 12 and smart poster 10 may thus include, e.g. a concatenated command chain including “start+thin+supreme+cheese+L+order.” Such an example command chain may be communicated to and parsed by product ordering server 18 to procure the pizza ordered by mobile device 12 via smart poster 10.

In some examples, the initiation and execution of a multi-dimensional function in accordance with this disclosure may be implied such that one or both do not require a selection by a user using a mobile device. With reference to the pizza ordering example of FIG. 1, a user may, instead of selecting “start,” may simply use mobile device 12 to select a first pizza parameter, e.g. crust type by passing mobile device 12 near one of the crust type parameter values, which serves to select that parameter value and initiate the function. Similarly, the “order” or other function execution selection may be implied and therefore may not require a separate label or associated tag on smart poster 10. For example, a user may, instead of selecting “order,” may simply use mobile device 12 to select a last pizza or order parameter, e.g. size by passing mobile device 12 near one of the size parameter values, which serves to select that parameter value and automatically execute the function.

There are a number of implementation options for the design of communication between mobile computing device 12 and the remote service/product provider, e.g. server 18 via network 14. For example, mobile device 12 can accumulate each component of the command chain as it scans each tag, and only send it to server 18 on completion. Alternatively, mobile device 12 may send each fragment of the command chain, e.g., each of a user's choices with respect to options for the pizza to server 18 and let the server decide what prompts, or status, or graphics to show on the display of mobile device 12. In one example, when the end marker is received by server 18, the function command is completed and, in the example of FIG. 1, the pizza is ordered. This may have a number of advantages as the graphics shown on mobile device 12 at each stage may be defined by server 18, and the command-chain session capable application on mobile device 12 can be designed to be as generic as possible, allowing for interactions with a large number of different smart posters/services with the same application. Additionally, although the disclosed examples may be described with reference to selecting parameter values via a mobile device interacting with tags on a visual media and then executing a multi-dimensional function based on such selections, in some examples, the function may not be executed immediately or soon after selecting the parameter values. For example, mobile device 12 or server 18 may store a function including the selected parameter values and mobile device 12 may retrieve and execute the function at a later time. Additionally, mobile device 12 may retrieve the function and/or one or more selected parameter values for review and modification prior to ultimately executing the function according to a number of values.

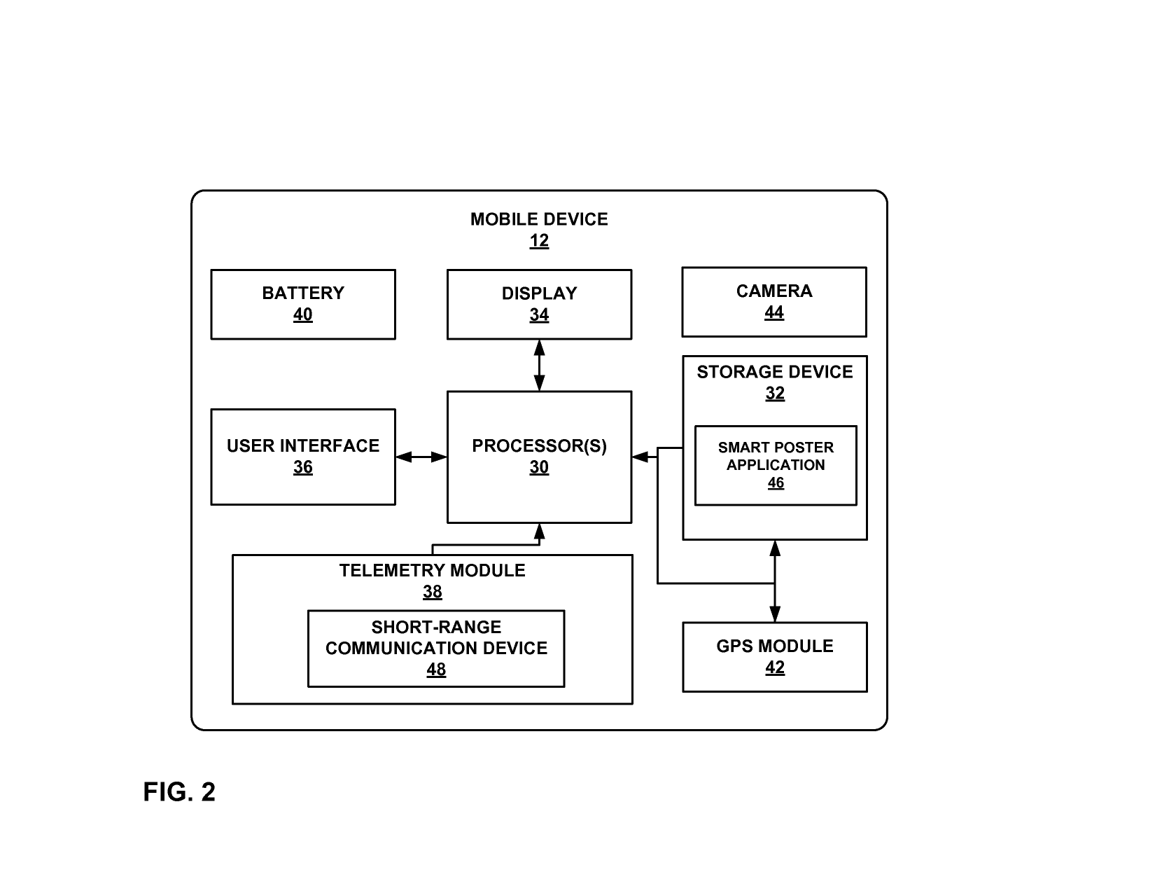

FIG. 2 is a block diagram illustrating an example configuration of mobile device 12 including processor 30, storage device 32, display 34, user interface 36, telemetry module 38, battery 40, Global Positioning System (GPS) module 42, and camera 44. In examples where device 12 is a cellular phone, the device may also include a microphone and speaker (not shown) for voice communication. Processor 30, generally speaking, is communicatively connected to and controls operation of storage device 32, display 34, user interface 36, telemetry module 38, and GPS module 42, all of which are powered by rechargeable battery 40. Processor 30 may include any one or more of a microprocessor, a controller, a digital signal processor (DSP), an application specific integrated circuit (ASIC), a field-programmable gate array (FPGA), or equivalent discrete or integrated logic circuitry. The functions attributed to processor 30 in this disclosure may be embodied as software, firmware, hardware and combinations thereof. Although example mobile device 12 of FIG. 2 is illustrated as including one processor 30, other example mobile devices according to this disclosure may include multiple processors that are configured to execute one or more functions attributed to processor 30 of mobile device 12 individually or in different cooperative combinations.

Storage device 32 stores instructions for applications that may be executed by processor 30 and data used in such applications or collected and stored for use outside of mobile device 12, e.g. smart poster application 46 and data associated therewith. Storage device 32 may be a computer-readable, machine-readable, or processor-readable storage medium that comprises instructions that cause one or more processors, e.g., processor 30, to perform various functions. Storage device 32 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media. Generally speaking, storage device 32 may include instructions that cause processor 30 to perform various functions attributed to the processor 30 in the disclosed examples.

Storage device 32 includes memory that stores software that may be executed by processor 30 to perform various functions for a user of mobile device 12, including, e.g., making and receiving cellular telephone calls or other communications like text or e-mail messages, using various software applications, and browsing the Internet. The software included in mobile device 12 generally includes telemetry and other hardware drivers for the mobile device, operating system software, and applications software, including location tracking application 44 and symptom reporting application 46. The operating system software of mobile device 12 may be, e.g. Linux software or another UNIX based system software. In another example, mobile device 12 may include proprietary operating system software not based on an open source platform like UNIX. Mobile device 12 may also include various applications stored on storage device 32 and executed by processor 30, including, e.g., web browser, calendar, contact management, and e-mail applications, as well as various types of third-party vendor applications bundled with the device. In the example of FIG. 2, mobile device 12 includes smart poster application 46, stored on storage device 32 and executable by processor 30. Smart poster application 46 may be configured to facilitate interaction between mobile device 12 and a variety of visual media including tags interpretable by device 12, e.g. NFC tags with which mobile device 12 communicates via short-range communication device 48 of telemetry module 38 to electronically execute a multi-dimensional function presented by the visual media including the tags.

Operation of mobile device 12 may require, for various reasons, receiving data from one or more sources including, e.g. product ordering server 18, as well as transmitting data from the mobile device, e.g. data stored on storage device 32 to one or more external sources, which may also include server 18 of system 8. For example, mobile devices 12 may be configured to communicate pizza order data to product ordering server 18 via network 14.

Data communications to and from mobile device 12 may be managed by telemetry module 38. Telemetry module 38 is configured to transmit data/requests to and receive data/responses from one or more external sources via network 14. Telemetry module 38 may support various wireless communication techniques and protocols, and includes appropriate hardware and software to provide such communications. For example, telemetry module 38 may include an antenna, modulators, demodulators, amplifiers, and other circuitry to effectuate communication between mobile device 12 and server 18 via network 14.

In the example of FIG. 2, telemetry module 38 includes short-range communication device 48 for facilitating communication with tags on a visual media, like smart poster 10 from system 8 of FIG. 1. In one example, short-range communication device 48 may be an NFC device. As described herein, short-range communication device 48 may be active hardware that is configured to obtain information from, e.g. NFC tags on a visual media presenting a multi-dimensional function, like the pizza ordering function of smart poster 10. Short-range communication device 48 may be configured to communicate wirelessly with other devices in relatively close proximity to short-range communication device 48 (e.g., approximately 0-100 meters, or, in some examples, approximately 0-1 meter). In other examples, short-range communication device 48 may be replaced with an alternative short-range communication device configured to obtain information from various tags on a smart poster or other visual media. These alternative short-range communication devices may operate according to Bluetooth, Ultra-Wideband radio, or other similar protocols.

Mobile device 12 also includes camera 44, which may be or include an optical sensor that mobile device 12 controls. Mobile device 12 may capture images and/or video using camera 44. Camera 44 may be located on any of a number of exterior surfaces of mobile device 12. In some examples, mobile device 12 may include two or more cameras. In some examples, camera 44 may be used to interpret optical tags on a visual media, like QR codes on smart poster 10. For example, camera 44 of mobile device 12 may be used to take a picture of a QR code associated with a parameter of a function presented on a visual media. In the example of FIG. 1, smart poster 10 may include QR codes visually presented on the poster in association with one or more of the pizza order options, e.g. in association with the types of crust and specialty pizzas, toppings, and sizes. Mobile device 12, e.g. processor 30 of mobile device 12 may be configured to analyze a digital photograph taken by camera 44 to read a QR code tag on poster 10, e.g. to determine that a user has selected a thin crust pizza as part of a pizza order. In some examples according to this disclosure, a combination of NFC or other electronic tags and barcode, e.g. QR code or other optical tags may be used in combination on a single visual media, thus allowing for the use of both camera 44 and short-range communication device 48 to interact with the visual media and electronically execute the multi-dimensional function presented thereby.

Mobile device 12 includes display 34, which may be, e.g., a liquid crystal display (LCD), light emitting diode (LED) display, e-ink, or other display. Display 34 presents content from mobile device 12 to a user, e.g. content related to executing a function presented on a visual media like ordering a pizza via interaction with smart poster 10. In one example, display 34 may present applications executed on device 12 such as a web browser or a video game, as well as information about the mobile device, including, e.g., battery life and/or network signal strength. In some examples, display 34 may provide some or all of the functionality of user interface 36. For example, display 34 may be a touch screen that allows the user to interact with mobile device 12 to change parameters of a function using smart poster application 46. In generally, however, user interface 36 allows a user of mobile device 12 to interact with the device via one or more input mechanisms, including, e.g., an embedded keypad, a keyboard, a mouse, a roller ball, buttons, scroll wheel, touch pad, touch screen, or other devices or mechanisms that allow the user to interact with the device.

In some examples, user interface 36 may include a microphone to allow a user to provide voice commands. Users may interact with user interface 36 and/or display 34 to execute one or more of the applications stored on storage device 32, including smart poster application 46. Some applications may be executed automatically by mobile device 12, such as when the device is turned on or booted up. Processor 30 executes the one or more applications stored on storage device 32, and selected by a user via user interface 36 or automatically executed by mobile device 12.

Mobile device 12 may also include one of more GPS modules 42. GPS module 42 may include one or more satellite radios capable of determining the geographical location of mobile device 12. Mobile device 12 may utilize GPS device 42 to confirm the validity of a visual media with which mobile device 12, for example. Alternatively, mobile device 12 may transmit the GPS coordinates to remote product ordering server 18 to identify the location and the specific visual media with which the device is interacting.

Battery 40 provides power for all if the various components of mobile device 12, and may be rechargeable. Examples of battery 40 include a lithium polymer battery, a lithium ion battery, nickel cadmium battery, and a nickel metal hydride battery.

Although the foregoing examples have been described with reference to mobile device 12 including smart poster application 46 for use in conjunction with, e.g. product ordering server 18 to order pizzas electronically using mobile device 12 and smart poster 10, in other examples such function/processing applications or other mechanisms configured to operate in accordance with the disclosed examples may be physically and/or logically differently arranged. For example, mobile device 12 may only include short-range communication device 48 and/or camera 44 for interpreting various types of tags on a visual media, like smart poster 10 and may not need a particular software application for electronically executing a function presented on a visual media, e.g. ordering a pizza. In one such example, tags included in smart poster 10 may include the information necessary to initiate and terminate communications with product ordering server 18 via network 14, including, e.g. instructions automatically executable by processor 30 of mobile device 12 when the device is brought into close proximity with smart poster 10 or a particular tag thereon or embedded therein.

Additionally, although mobile device 12 of FIG. 2 is shown as including display 34, aspects of this disclosure should not be considered limited to example mobile devices that include a display. In some examples of mobile device 12, display 34 may be optional. For example, in some examples in which mobile device 12 is a music player or a radio, the device may not include a display.

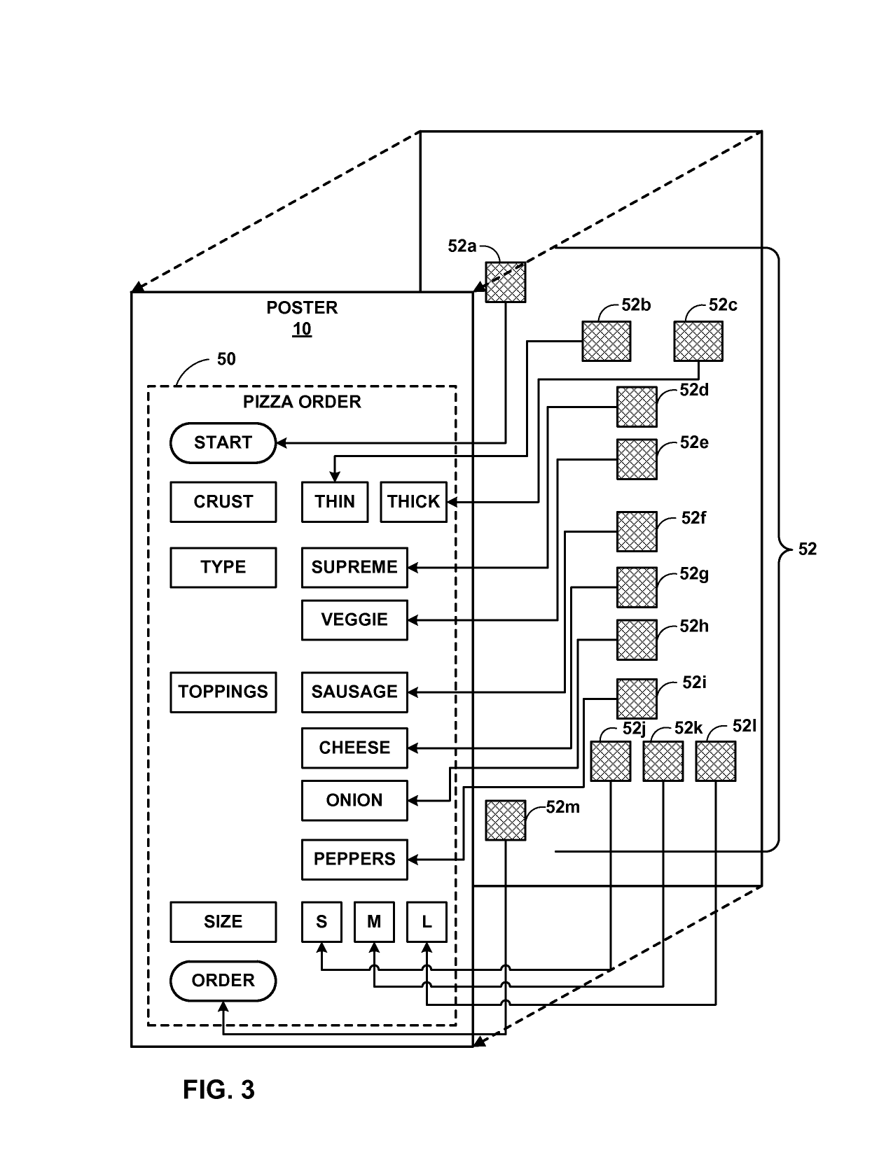

FIG. 3 is a block diagram illustrating an example configuration of smart poster 10 including visual media 50 associated with the pizza ordering function presented on the poster and a number of NFC tags 52 (collectively), each of which is associated with various parameters of the pizza ordering function. In FIG. 3, smart poster 10 includes visual media 50 including labels for starting (“start” label) and completing (“order” label) a pizza order, selecting a crust type as thin or thick, a specialty pizza type as supreme or veggie, toppings including sausage, cheese, onion, peppers, and a size including small, medium, and large. A number of the labels of visual media 50 of poster 10 are respectively associated with NFC tags 52, which in the example of FIG. 3 are illustrated as embedded in poster 10 behind the respective labels. As illustrated in FIG. 3, NFC tag 52a is associated with the “start” label of visual media 50 of poster 10. NFC tag 52b is associated with the “thin” crust option for the crust type parameter. NFC tag 52c is associated with the “thick” crust option for the crust type parameter. NFC tag 52d is associated with the “supreme” pizza option for the specialty pizza type parameter. NFC tag 52e is associated with the “veggie” pizza option for the specialty pizza type parameter. NFC tag 52f, 52g, 52h, and 52i are respectively associated with the “sausage,” “cheese,” “onion,” and “peppers” options for the toppings parameter. NFC tags 52j, 52k, 52l are respectively associated with the small (“S”), medium (“M”), and large (“L”) options for the size parameter. Finally, NFC tag 52m is associated with the “order” label of visual media 50 on smart poster 10.

As noted above with reference to FIG. 1, any of NFC tags 52 may be configured as either active or passive short-range communication devices and may operate in accordance with the functions of such devices as described above. Additionally, although the example of FIG. 3 is illustrated and described as smart poster 10 including NFC tags 52 associated with labels of visual media 50, in another example, one or more of the labels associated with the parameters of the pizza ordering function may be interacted with by mobile device 12 via different types of tags, like QR code tags.

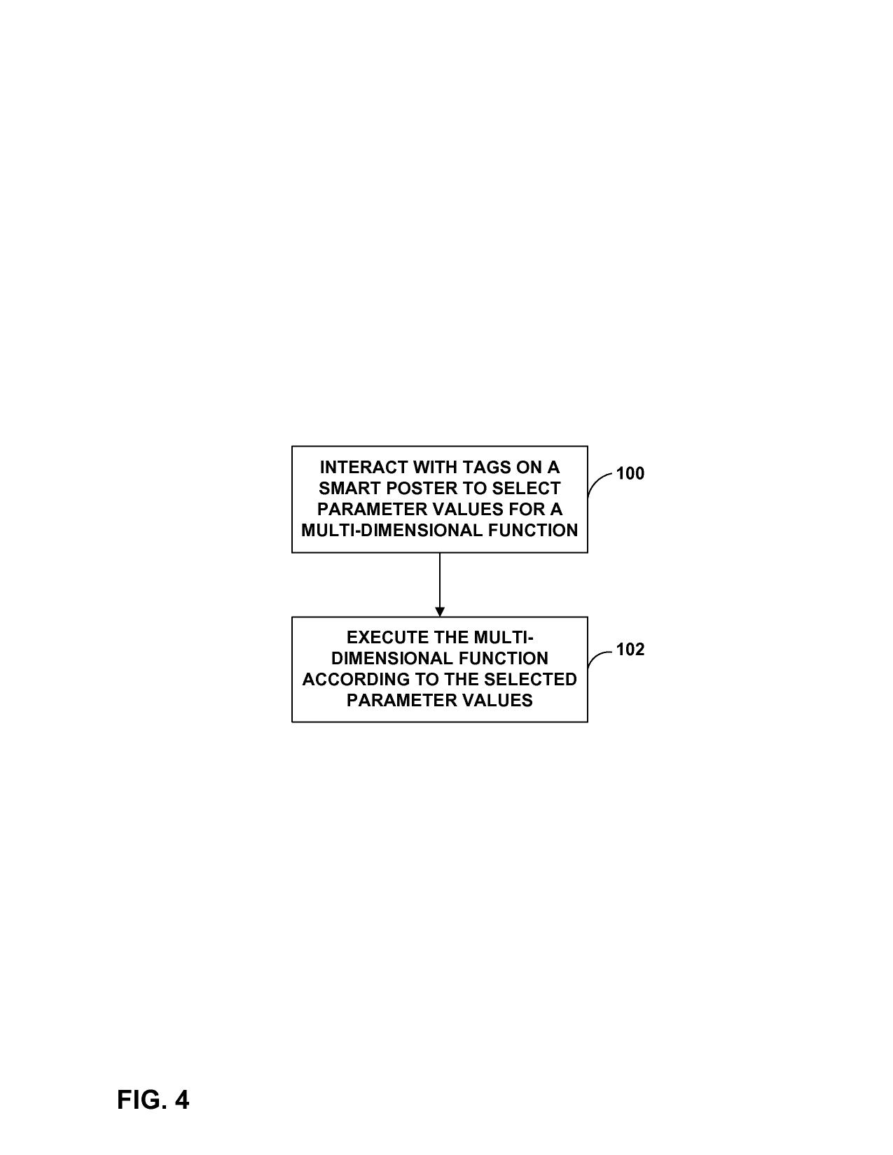

FIG. 4 is a flowchart illustrating an example of using a mobile computing device to electronically execute a multi-dimensional function presented on a visual media including a plurality of tags associated with a plurality of parameters of the multi-dimensional function, each of which tags is interpretable by a mobile computing device. The method FIG. 2 includes interacting, by the mobile computing device, with two or more of the tags of the visual media to select values for two or more of the parameters of the function (100) and executing the function according to the selected values for the two or more parameters (102). The method of FIG. 4 may be executed by one or more components of system 8 of FIG. 1 to order a pizza or may be executed by different systems to execute different functions. For example, the method of FIG. 4 may be executed in the context of an interactive shopping poster at a store, e.g. a big box electronics store that allows a user to filter and navigate through a large array of product choices, e.g. a list of 100 televisions sold at the store. In general, however, the method of FIG. 4 may be applied to electronically execute any multi-dimensional function presented on a smart poster using a mobile device, thus enabling smart poster interaction with sessions containing command-chains including multiple parameters.

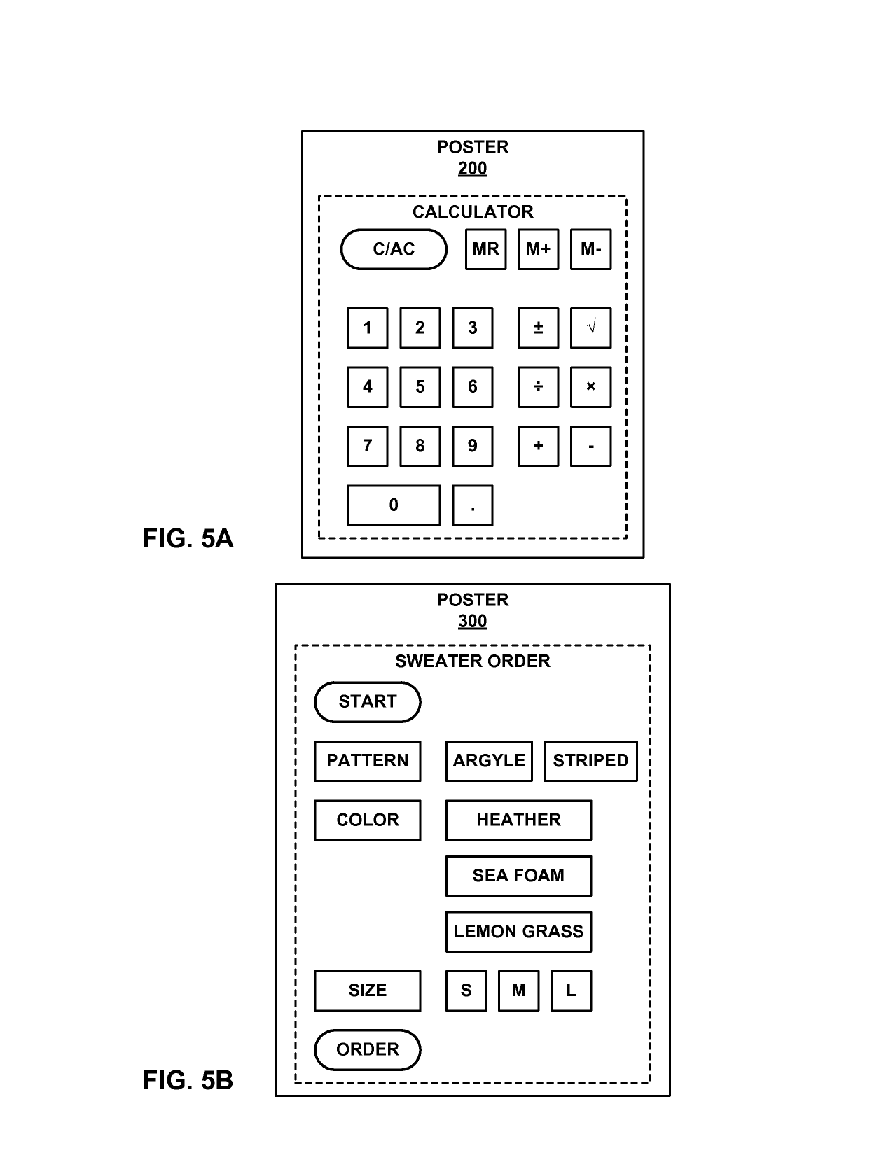

Two alternative examples according to this disclosure are illustrated in FIGS. 5A and 5B by block diagrams of sample smart posters 200 and 300, respectively. FIG. 5A is a block diagram illustrating smart poster 200, which presents a calculator for executing one or more mathematical functions electronically via a mobile device, e.g. mobile device 12 interacting with tags associated with labels on poster 200. FIG. 5B is a block diagram illustrating smart poster 300, which presents a sweater ordering function for electronic execution by a mobile device, e.g. mobile device 12 interacting with tags associated with labels on poster 300. Interaction with and function execution for each of smart posters 200 and 300 may be carried out in conjunction with tags on the posters, a mobile device and remote computing devices in substantially similar manner as described with reference to the examples of FIGS. 1-4.

For example, with reference to smart poster 200 illustrated in FIG. 5A, a mathematical function may be defined by a user of a mobile device placing the device in proximity with or tapping a number of numeric values and one or more mathematical operators, e.g. addition, +, subtraction, −, multiplication, ±, division, ÷, and other operators on poster 200 with which NFC tags are associated. Then the function defined by the selected numbers and operators may be calculated locally by the mobile device or remotely by a server with which the mobile device communicates over a network like network 14 in the example of FIG. 1.

Example smart poster 300 of FIG. 5B illustrates a sweater ordering function presented to a user and electronically executable with a mobile device. In the example of FIG. 5B, smart poster 300 includes visual media related to different options for ordering a sweater electronically, including the sweater pattern, color, and size. Portions of the visual media on poster 300 may be associated with tags, e.g. NFC tags interpretable by a mobile device, like mobile device 12 to select different values for parameters of the sweater a user wishes to order. For example, the values presented on smart poster 300 for pattern, argyle or striped, color, heather, sea foam, or lemon grass, and size, small, medium, or large, may each be associated with an NFC or other type of tag that may be interacted with by mobile device 12 to configure the sweater order according to a number of the different possible values. Additionally, similar to poster 10 of FIG. 1, smart poster 300 includes “start” and “order” labels for initiating and completing the sweater order.

As noted above, in some examples, functions such as the sweater ordering function of FIG. 5B may not be executed immediately or soon after selecting the parameter values like pattern, color, and size. For example, a user may see poster 300 and be interested in purchasing a sweater but unsure or unready to purchase immediately. In such a case, the user may employ a mobile phone to select a sweater they may want to purchase, e.g. by tapping their phone against the labels and associated tags for pattern, color, and size. The user, in one example, may then store the parameter values, e.g. argyle, sea foam, and medium, before ultimately ordering the sweater. Additionally, the user may retrieve the stored function and/or one or more of the parameter values to review, e.g. on a mobile device display and, in some cases, modify one or more parameters before ordering a sweater.

In some examples according to this disclosure, multi-dimensional functions electronically executed by a mobile device interacting with a smart poster may include programmatic functions, including, e.g. conditional parameter selections, like “if, then” type functions and looping functions, like “while, do” type functions. With reference to the example of FIG. 5B of ordering a sweater, smart poster 300 my include options for ordering multiple sweaters in a single order. For example, smart poster 300 may include a label and associated NFC or other type of tag that indicates a user would like to order multiple sweaters. The user could, in such a case, pass their mobile device over the “multiple” label and then select a number from 1 to N also presented on smart poster 300 to indicate how many sweaters are to be ordered. The user could then cycle through multiple parameter selections, e.g. selecting pattern, color, and size N times for N different sweaters using a mobile device in proximity to the labels and associated tags of smart poster 300 until the indicated number was reached and the order completed.

In another example that includes functions that may be repeated periodically by a user, like ordering the same pizza or sweater, functions may be included for saving the parameter value set for a particular multi-dimensional function such that it can be easily and quickly recalled in the future. For example, an application stored and executed on a user's mobile device, e.g. smart poster application 46 stored on storage device 32 and executed by processor 30 of mobile device 12 may provide a user of mobile device 12 an option to save one or more pizza orders, e.g. by storing them on storage device 32, or on server 18 communicated over network 14. In such an example, the next time the user of mobile device 12 wanted to order a pizza and was close to smart poster 10 or another smart poster from the same provider, smart poster application 46 could be employed to recall the saved orders, which could be saved command chains as described above like “start+thin+supreme+cheese+L+order,” and then execute the pizza ordering function according to the saved pizza parameter value selections.

In another example, the functions for storing parameter value selections for a function could also be executed using labels and tags on the visual media, e.g. smart poster 10, instead of using only smart poster application 46. For example, smart poster 10 may include labels and associated tags like “Memory #1” to “Memory #N,” or, “Order #1” to “Order #N” that a user could select with mobile device 12 to store an order and smart poster 10 could also include a “Recall #N” button to recall stored orders at a future time. The saved pizza order(s) could still be stored on mobile device 12, e.g. on storage device 32 of mobile device 12 or communicated over network 14 and stored on server 18.

The concept of storing command chains and later recalling them, as described above, could also be used to enable more complicated programmatic functions. For example, an “IF,” “THEN,” and “ELSE” structure, e.g. implemented using “IF,” “THEN,” and “ELSE” labels and associated tags on a visual media like smart poster 10 could be used, for example, to accommodate and adjust for unavailability of items in an order. For example, a command chain that included a statement equivalent to “IF” veggie pizza is unavailable, “THEN” substitute marinated tomatoes+extra cheese, “ELSE” add sun dried tomatoes, or “IF” veggie is unavailable, “THEN” substitute margarita, “ELSE” add extra green peppers. In another example, saved orders could be used as part of an “IF, THEN” command chain. For example, “IF” “Order #1” is unavailable, “THEN” substitute “Order #2.” In one example, a “WHILE, DO” type programmatic structure could also be used in a command chain employed to electronically execute a multi-dimensional function presented on visual media using a mobile computing device. For example, a command chain that included a statement equivalent to “WHILE” time of year is summer “OR” autumn, “DO” drink is Coke, “WHILE” time of year is winter “OR” spring, “DO” drink is coffee.

“IF, THEN” and “WHILE, DO” structures could be generated by a user constructing them using their mobile device to pass over command labels on the visual media, e.g. “IF,” “THEN,” “WHILE,” and “DO” labels and associated tags on a smart poster, along with parameter value selections that are included in the programmatic command chains. For example, labels and associated tags could be included in a smart poster for each of “WHILE” “WINTER” “OR” “SPRING” “DO” “DRINK” “COFFEE” for executing a command chain for season dependent drink selections, as illustrated in the foregoing example. Additionally, such command chains could be stored in memory, e.g. on storage device 32 of mobile device 12 and then recalled to execute them alone or as part of a larger order. For example, as part of a pizza order the conditional “WHILE, DO” loop for selecting a drink could be recalled using smart poster application 46 via mobile device 12 such that the user of mobile device 12 would receive the correct drink with their pizza regardless of the time of the year.

Examples according to this disclosure have a number of advantages. Employing a mobile device preconfigured with hardware and/or software, which is generic to a wide variety of functions, to electronically execute a multi-dimensional function via interaction with, e.g. tapping a visual media like a smart poster may provide an attractive and efficient means for product manufacturers and distributers to encourage consumers to execute commercial transactions. The mechanisms for implementing such techniques are, in the case of mobile devices, already in the hands of consumers and, in the case of smart posters or other visual media, inexpensive and simple to produce and distribute. Additionally, the act of executing the function is intuitive and easy for any consumer to understand and practice. For example, walking up to a poster and tapping options on the poster with your mobile phone and then selecting “order” may require no special training in user interfaces, downloading and installing software, or updating such software periodically. Thus, consumers may find executing orders and other functions using a mobile phone and a smart poster easy and even fun. The ease and efficiency of executing orders or other functions in accordance with examples of this disclosure may provide consumers with a number of intangible benefits, as well, including, e.g., relieving them of the aggravation of standing in “check-out” lines to purchase a product.

Product providers may also receive a number of benefits from examples according to this disclosure, including reduced staffing needs and space requirements, as “check-out” lines and staff may not even be required in a store in which all of the products include associated smart posters with which consumers can interact to configured and order products. A limited number of staff members may be on hand, e.g. to answer questions, allow access to dressing rooms, etc. Product providers may well also see an increase in incremental sales by employing systems in accordance with this disclosure, as the ease and efficiency of the purchasing process may lead consumers to buy more goods.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

In some examples, computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method of electronically executing a multi-dimensional function presented on a visual media, the method comprising:
interacting, by a mobile computing device, with two or more of a plurality of tags associated with the visual media to select values for two or more of a plurality of parameters of the multi-dimensional function, wherein the plurality of tags associated with the visual media are associated with the plurality of parameters of the multi-dimensional function, and wherein each of the plurality of tags is interpretable by the mobile computing device; and
executing the multi-dimensional function according to the selected values for the two or more parameters, wherein the multi-dimensional function is a function that requires, for execution, values of two or more of the plurality of parameters.

2. The method of claim 1, wherein one or more of the tags comprise at least one of optical or electronic tags.

3. The method of claim 2, wherein the optical tags comprise barcode tags, and wherein interacting, by the mobile computing device, with the two or more of the tags comprises obtaining one or more digital images of each of the two or more tags with a digital camera of the mobile computing device.

4. The method of claim 2, wherein the optical tags comprise two-dimensional barcode tags.

5. The method of claim 1, wherein the electronic tags comprise near field communication (NFC) tags, and wherein interacting, by the mobile computing device, with the two or more of the tags comprises the mobile computing device coming within approximately 0-approximately 1 meter of the visual media near each of the two or more NFC tags.

6. The method of claim 1, wherein the function comprises an electronic commercial transaction for a product, and wherein the plurality of parameters comprise a plurality of optional characteristics of the product.

7. The method of claim 6, wherein interacting, by the mobile computing device, with the two or more of the tags comprises interacting with at least one tag associated with each of the plurality of characteristics of the product to select a value for each characteristic, and wherein executing, by the mobile computing device, the electronic commercial transaction comprises submitting an electronic order to purchase the product comprising the selected values for each of the respective characteristics of the product.

8. The method of claim 1,
wherein the function comprises a mathematical operation, and wherein interacting, by the mobile computing device, with the two or more of the tags comprises selecting with one or more tags associated with one or more numbers between 0 and 9 and one or more mathematical operators, and
wherein executing the mathematical operation comprises computing a result of a function defined by the one or more numbers between 0 and 9 and the one or more mathematical operators associated with the one or more selected tags.

9. The method of claim 8, further comprising displaying the result of the computed function on a display of the mobile computing device.

10. The method of claim 1, wherein the plurality of tags comprise at least one initialization tag configured to indicate a start of the function, at least one completion tag configured to indicate a completion of the function, and a plurality of parameter value tags configured to indicate different values of some of the plurality of parameters of the function.

11. The method of claim 10,
wherein interacting, by the mobile computing device, with the two or more of the tags comprises:
interacting with the initialization tag; and
after interacting with the initialization tag, interacting with each of the parameter value tags; and
wherein executing the function according to the selected values for the two or more parameters comprises, after interacting with each of the parameter value tags, interacting, by the mobile computing device, with the completion tag.

12. The method of claim 11, wherein interacting, by the mobile computing device, with the initialization tag, the parameter value tags, and the completion tag comprises:
interpreting the initialization tag to receive an initialization marker;
interpreting each of the parameter value tags to receive a parameter value and continuation marker from each tag;
interpreting the completion tag to receive a completion marker; and
concatenating the initialization marker, the parameter values and continuation markers, and the completion marker to generate a command chain.

13. The method of claim 12, wherein executing the function comprises executing the function according to the command chain.

14. The method of claim 12, further comprising:
after interpreting the initialization tag and each of the parameter value tags, concatenating the initialization marker, the parameter values and continuation markers; and
after interpreting the completion tag, concatenating the concatenated initialization marker, parameter values and continuation markers, and the completion marker to generate the command chain.

15. The method of claim 14, further comprising storing, by the mobile computing device, the initialization marker, the parameter values and continuation markers, the concatenated initialization marker, parameter values and continuation markers, and the completion marker.

16. The method of claim 1, further comprising storing, by the mobile computing device, the function including the selected values for the two or more parameters.

17. The method of claim 16, further comprising:
retrieving, by the mobile computing device, the function including the selected values for the two or more parameters; and
executing the function a second time according to the selected values for the two or more parameters.

18. The method of claim 1, wherein the plurality of tags comprises a plurality of programmatic command tags, the method further comprising:
interacting, by the mobile computing device, with at least one of the tags of the visual media to select at least one value for at least one of the parameters of the function;
interacting, by the mobile computing device, with one or more of the programmatic command tags to select one or more programmatic commands; and
concatenating the at least one value for the at least one of the parameters of the function and the one or more programmatic commands to generate a programmatic command chain.

19. The method of claim 18, further comprising storing, by the mobile computing device, the programmatic command chain.

20. The method of claim 18, wherein the plurality of programmatic command tags are selected from the group consisting of “IF,” “THEN,” “ELSE,” “WHILE,” “DO,” “AND,” “OR” tags, and combinations thereof.

21. A mobile computing device comprising:
a processor configured to:
receive data indicative of interactions with a plurality of tags associated with a plurality of parameters of a multi-dimensional function presented on a visual media, wherein each of the plurality of tags is interpretable by the mobile computing device, and wherein the data indicates interactions with two or more of the plurality of tags of the visual media to select values for two or more of the plurality of parameters of the multi-dimensional function; and
execute the multi-dimensional function according to the selected values for the two or more parameters, wherein the multi-dimensional function is a function that requires, for execution, values of two or more of the plurality of parameters.

22. The mobile computing device of claim 21, further comprising at least one of a digital camera and a near-field communication (NFC) device configured to interact with the plurality of tags, wherein the processor is configured to receive, from at least one of the digital camera and the NFC device, the data indicative of interactions with the plurality of tags.

23. The mobile computing device of claim 21, wherein one or more of the plurality of tags comprise at least one of optical or electronic tags.

24. A computer-readable storage device comprising instructions for causing at least one programmable processor to perform operations comprising:
receiving data indicating interactions with two or more tags of a visual media comprising a plurality of tags to select values for two or more parameters of a multi-dimensional function presented on the visual media, wherein each of the plurality of tags is interpretable by a computing device; and
executing the multi-dimensional function according to the selected values for the two or more parameters, wherein the multi-dimensional function is a function that requires, for execution, values of two or more of the plurality of parameters.
